(19) United States
(12) Patent Application Publication
(10) Pub. No.: US 2026/0124563 A1
(43) Pub. Date: May 7, 2026

(54) FILTER SYSTEM EQUIPPED WITH FILTER MOUNT AND FILTER INVENTORY

(71) Applicant: Caterpillar Inc., Peoria, IL (US)

(72) Inventors: Bryan Warren Rickards, Edwards, IL (US); Rhett Polson, Dunlap, IL (US); Adam Farhan, Chicago, IL (US); Michael Murray, Lake in the Hills, IL (US); Mitsunobu Okamoto, Yokosuka (JP); Jon Tyler Immel, Chillicothe, IL (US); Kenji Tachibana, Yokosuka (JP)

(73) Assignee: Caterpillar Inc., Peoria, IL (US)

(21) Appl. No.: 18/934,398

(22) Filed: Nov. 1, 2024

(51) Int. Cl. B01D 29/96

(52) U.S. Cl. CPC B01D 29/96; B01D 2201/291; B01D 2201/4053

(57) ABSTRACT

A filter mount includes a filter base including a filter base body defining an axis extending in a direction away from the filter base body, and a mounting portion for a filter element located at a distance from the filter base body. The filter mount also includes a freely rotatable attachment ring connected to the mounting portion. The attachment ring includes an annular portion having an inner attachment ring surface extending around the axis, and an attachment portion having a plurality of keys axially extending in the direction away from the filter base body. A filter inventory, filter mount, and related methodology are also disclosed.

### TECHNICAL FIELD

The present disclosure relates generally to a filter system, and more particularly to a filter mount and a filter inventory.

### BACKGROUND

Various machinery and vehicles are known throughout the world which utilize filters for various purposes. Most, if not all, machinery and vehicles equipped with a diesel engine, for example, filter the diesel fuel and other fluids to remove impurities that can interfere with operation of the engine, or the combustion process itself. These filters have a filter efficiency, which can define how effectively it removes particles or contaminants from a particular fluid. As particles are collected in the filter media the performance of the filter can degrade over time, potentially leading to fuel flow becoming impeded, degradation of filter performance, or other problems. For these reasons it is generally conventional practice to change out fuel filters on a regular service interval, or when diagnostic equipment indicates a filter change is needed. When replacing the filter, attention should be given to the replacement filter to ensure the desired requirements are met.

In some applications, machinery and vehicles may be specifically engineered for certain filtration performance and efficiency. In other applications, machinery and vehicles can be engineered to utilize various filters each having a different efficiency, with the selection of a particular filter based upon the judgment of the operator, or based on various factors, including cost. Filters of the same size and differing efficiency performance can look similar. For this reason, among others, identifying and correcting the use of an inappropriate or undesired filter can be time consuming. Filters and related equipment often employ some type of mechanism for positioning components in place and/or locking or restricting installation of incorrect components, but certain drawbacks are nevertheless inherent to these designs. For example, in many designs, users cannot easily visually determine if the filter has the desired filtration performance and efficiency. One example replaceable filter configuration in a liquid filter context is known from U.S. patent application Ser. No. 17/331,267 to Schneidewend et al.

### SUMMARY

In one aspect, a filter system includes a filter element defining a filter axis extending between a first axial end and a second axial end. The filter system also includes a filter medium extending circumferentially around the filter axis, and an end cap connected to the first axial end. The end cap includes a plurality of notches extending radially inward, formed within the end cap. The filter system also includes a filter base defining an axis having a mounting portion and an attachment ring connected to the mounting portion. The attachment ring includes at least one key positionable within a corresponding one of the plurality of notches, the at least one key axially extending in a direction away from the mounting portion.

In another aspect, a filter mount includes a filter base including a filter base body defining an axis extending in a direction away from the filter base body, and a mounting portion for a filter element located at a distance from the filter base body. The filter mount also includes a freely rotatable attachment ring connected to the mounting portion. The attachment ring includes an annular portion having an inner attachment ring surface extending around the axis, and an attachment portion having a plurality of keys axially extending in the direction away from the filter base body.

In yet another aspect, an inventory of filter elements includes a first filter element defining a first axis extending away from a first axial end and a first filter medium extending circumferentially around the filter axis. The first filter element also includes a first end cap connected to the first axial end, the first end cap including a connector portion having a radial projection, and a first plurality of notches opening at a radially outward edge of the end cap. The inventory of filter elements also includes a second filter element defining a second axis extending away from a second axial end and a second filter medium extending circumferentially around the second filter axis. The second filter element also includes a second end cap connected to the second axial end, the second end cap including a connector portion having a radial projection, and a second plurality of notches opening at a radially outward edge of the second end cap. The first filter element defines a first filter performance factor, and the second filter element defines a second filter performance factor different from the first filter performance factor, and the first filter element and the second filter element are interchangeable for service in a fluid filter system.

### BRIEF DESCRIPTION OF DRAWINGS

FIG. 1 is a partially sectioned view, in perspective, of a filter system, according to one embodiment;

FIG. 2 is a perspective view of a filter mount, according to one embodiment;

FIG. 3 is a perspective view of an attachment ring for a filter mount, according to an embodiment;

FIG. 4 is a perspective view of an inventory of filters according to one embodiment;

FIG. 5 is a perspective view of an end cap for a filter element, according to an embodiment;

FIG. 6 is a perspective view of an attachment ring coupled to an end cap, according to an embodiment; and

FIG. 7 is an exemplary schematic view of key and notch configurations, according to an embodiment;

### DETAILED DESCRIPTION

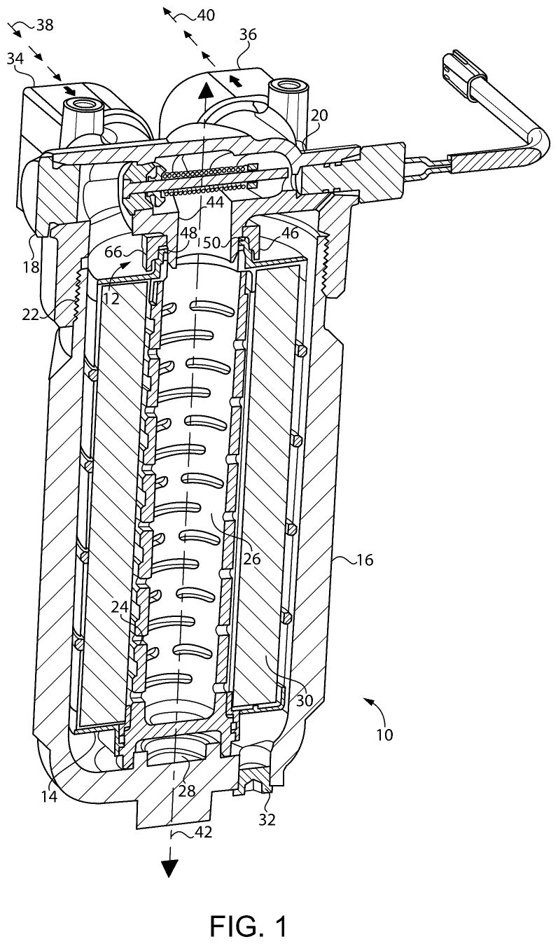

Referring to FIG. 1, there is shown a partial cross-section of a filter system 10, according to one embodiment. Filter system 10 may be structured to couple with or may be part of an internal combustion engine, such as a diesel engine. Filter system 10 can be used to remove impurities from a liquid fuel, such as a diesel distillate fuel, gasoline, naptha, or various blends, preventing water and other contaminants from reaching an engine. In addition to an application as a fuel filter, filter system 10 may be suitable for use with other liquid fluids, such as hydraulic fluid, transmission fluid, and still others. Filter system 10 may also include a filter mount 12 designed to accommodate a filter element 14 located within a filter housing 16. In a practical implementation, filter mount 12 may be designed with specific structures to facilitate the selective attachment of a filter element based on filtration requirements. These structures are designed to interact with corresponding features on filter element 14. The structural relationship between filter mount 12 and filter element 14 can ensure only desired filters are utilized based on various parameters, such as operational requirements, as further discussed herein.

Filter mount 12 may include a filter base 18 having a filter base body 20. Filter base body 20 has a filter housing attachment portion 22 designed to secure filter housing 16. Filter housing attachment portion 22 includes threads, however, it should be understood that other attachment strategies and/or features to secure filter housing 16 may also be incorporated, such as clamps, fasteners, and still others. As mentioned above, filter system 10 can remove contaminants from liquid fuels, including water and various types of particulates, which can be present in diesel fuel due to a variety of reasons, such as condensation formed on metal parts within various systems. In the context of an engine, these particulates can originate in situ or may be present in the fuel supplied to the engine.

To this end filter system 10 may include a filter center tube 24 forming an internal filter medium cavity 26 fluidly connected to a collection cavity 28. As shown in FIG. 1, filter element 14 includes filter medium 30 surrounding filter center tube 24. It should be appreciated that filter center tube 24 may be attached to, or potentially formed integrally with, filter housing 16. Collection cavity 28 can collect water as it drains during the filtration process and may further include a drainage plug 32 for the evacuation of collection cavity 28 following water accumulation. Filter base body 20 may also include an inlet port 34 and an outlet port 36, to facilitate a feeding of fluids to filter element 14 for filtration. An incoming flow 38 of a fluid to be filtered enters inlet port 34, water and debris are filtered by way of a filter medium 30 within filter housing 16, and an outgoing flow 40 of filtered fluid exits by way of outlet port 36.

During the filtration process, unfiltered fluid passes through filter medium 30, separating impurities such as particulates including metal bits, carbonized deposits, dirt, etc., and resulting in a filtered fluid. A variety of materials for filter media are known and commercially available, such as paper, polyester, activated carbon, etc. Filter medium 30 may exhibit various efficiencies, based upon predetermined or specific requirements, such as the ability to capture particles effectively and/or the ability to withstand operational conditions. Performance of a filter medium can be evaluated by a filter performance factor.

It should be understood that the term “filter performance factor,” denotes a quantitative or qualitative measure for evaluating filtration performance. The filter performance factor may utilize a number of parameters, which collectively define a filter medium's effectiveness and performance for capturing particles. For example, filter efficiency may be one parameter of the filter performance factor, along with filter longevity, suitability for service in certain fluids, through-flow capabilities, or still others. A filter performance factor might be a numerical value, such as “1,” “2,” “3,” etc., or may be identified according to a class, such as “A,” “B,” “C,” etc. Another way to understand this principle is that a high filter performance factor may indicate a filter highly efficient at removing contaminants from liquid fuel, and a low filter performance might indicate a filter less efficient at capturing contaminants, for generally analogous conditions. As will further become apparent from the present discussion, filter mount 12 includes features to provide a lock and key relationship with various filter elements. This structural relationship is leveraged to prevent the use of filter elements with undesired filter performance factors, or filters otherwise undesirable to install. In a practical implementation, a desired filter, or a filter having a desired filter performance factor for the application at hand, can be identified upon visual inspection of a filter element.

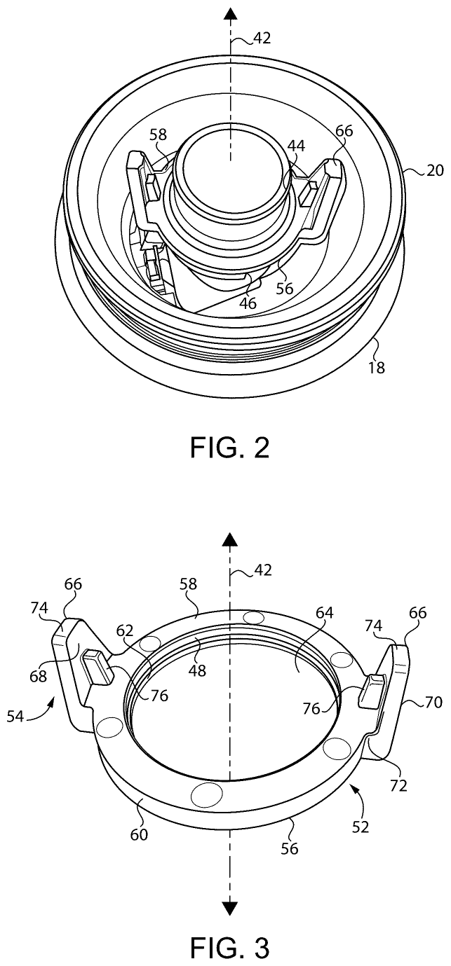

Now also referring to FIGS. 2 and 3, filter base 18 defines a filter axis 42 extending outward in a direction away from filter base body 20. Further, filter base body 20 may be equipped with a mounting portion 44 designed to accommodate a filter element located at a distance away. As shown in FIG. 2, mounting portion 44 axially extends away from filter base body 20, but is not limited to such. Filter elements of the same size and differing filter performance factors can look similar to one another. To selectively ensure a filter element with a desired filter performance factor is utilized, an attachment ring 46 may be positioned upon mounting portion 44. Attachment ring 46 features a projecting structural mechanism to restrict the installation of filter elements deemed undesirable.

Attachment ring 46 is structured to connect to mounting portion 44 and may further be designed to freely rotate about filter axis 42, relative to mounting portion 44. It should be appreciated that various strategies may exist for connecting attachment ring 46 to mounting portion 44. For example, as shown in FIG. 1 attachment ring 46 may further include a groove 48 formed within an inner attachment ring surface 62, and a rib 50 circumferentially extending around mounting portion 44 seated within groove 48, matingly coupling filter base 18 and attachment ring 46. In other examples, attachment ring 46 may be coupled to mounting portion 44 by alternative methods or integrally formed on mounting portion 44.

Attachment ring 46 includes an annular portion 52 circumferentially extending around filter axis 42, and an attachment portion 54 extending away from filter base 18. Annular portion 52 may include a second peripheral surface 58 oriented in a direction away from filter base body 20 and a first peripheral surface 56 oriented toward filter base body 20. Annular portion 52 also includes an outer attachment ring surface 60 and inner attachment ring surface 62 forming an opening 64. To facilitate the selective installation of filter elements, attachment portion 54 includes a plurality of keys 66 extending in a direction away from mounting portion 44 and filter base body 20.

As shown in FIGS. 2 and 3, attachment ring 46 has a total number of 2 keys, but is not limited to such, and the potential for additional keys or fewer keys is contemplated, provided the attachment configurations permit. Another way to understand this principle is that attachment ring must be equipped with at least 1 key, otherwise the corresponding attachment component on a filter element cannot utilize the selective installation features, as further discussed subsequently. For exemplary discussion, a plurality of keys may include a total number of 1, 2, 3, or 4 keys. Hereafter, the term “key” will be used in the singular form, but it should be understood that the present description of a “key” is applicable to both singular and plural instances. Key 66 includes a radially inward first key surface 68, and a radially outward second key surface 70. Key 66 may also extend from a key base 72, coupled to annular portion 52, to a key tip 74. It should be appreciated that each key base 72 may be integrally formed within annular portion 52 or alternatively, each key base 72 can be added to annular portion 52 through a secondary manufacturing process.

In a practical implementation, keys 66 are radially distributed about filter axis 42, such that each key 66 is positioned no less than one-quarter of the angular distance around attachment ring 46. A radial placement of each respective key 66 about filter axis 42, provides spaced apart attachment regions when installing filter element 14. In one example, key 66 may also extend at an angle outward relative to filter axis 42 from key base 72 to key tip 74, which can enhance the alignment process by providing a more accommodating position. In another example, key 66 may include a narrowing inward taper, from key base 72 to key tip 74. A detent element 76 may be located on first key surface 68, so that upon coupling a filter element to mounting portion 44, detent element 76 can secure the filter element into position. A variety of forms, shapes, arrangements, and a total number of keys are contemplated herein.

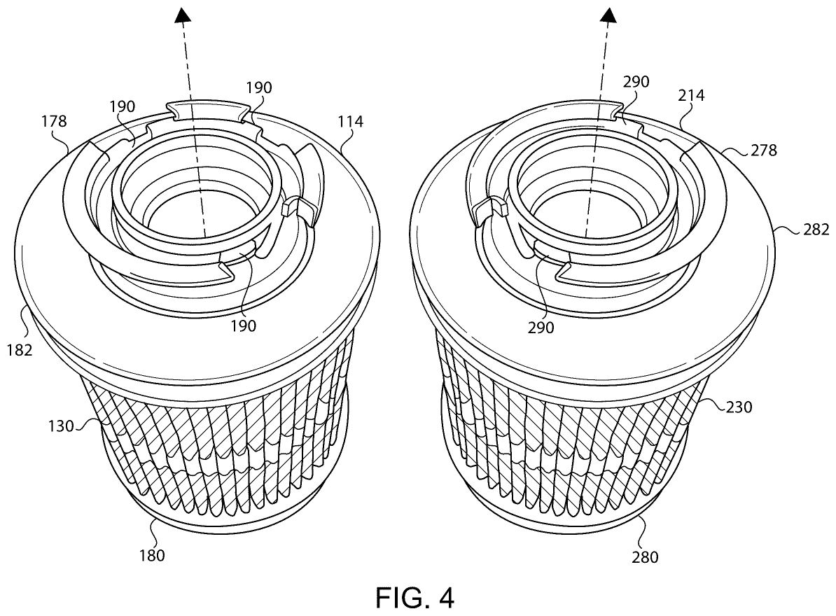

FIG. 4 shows an inventory of filter elements 114, 214 according to one embodiment. Each filter element shown in FIG. 4 may be substantially identical except as otherwise specified. Filter element 114, 214 may be coupled to filter center tube 124, 224 (not shown in FIG. 4), and filter element 112, 214 defines a filter axis 142, 242 extending away from a first axial end 178, 278 toward a second axial end 180, 280. When filter element 114, 214 is attached to filter base body 20, filter axis 142, 242 may coincide with filter axis 42. Filter element 114, 214 may also include filter medium 130, 230 extending circumferentially around filter center tube 124, 224.

Now turning to distinctions between filter elements 114, 214. It should be understood that within the forthcoming discussion, designation of element numbering is used to further differentiate filter element 114 from filter element 214. Filter element 114 includes filter medium 130 defining a first filter performance factor and filter element 214 includes filter medium 230 defining a second filter performance factor. In one example, the first filter performance factor is different than the second filter performance factor. In a practical implementation, the first filter performance factor may be or include a higher filtration efficiency than a filtration efficiency associated with the second filter performance factor. In other examples, filter medium 130 may be formed of a finer mesh or dense material composition, and filter medium 230 may be formed of a coarse mesh or a less dense material composition. As mentioned elsewhere, filters with varying efficiencies can look similar. For convenience, the first filter performance factor is indicated with a first line pattern on filter medium 130 and the second filter performance factor is indicated with a second line pattern on filter medium 230.

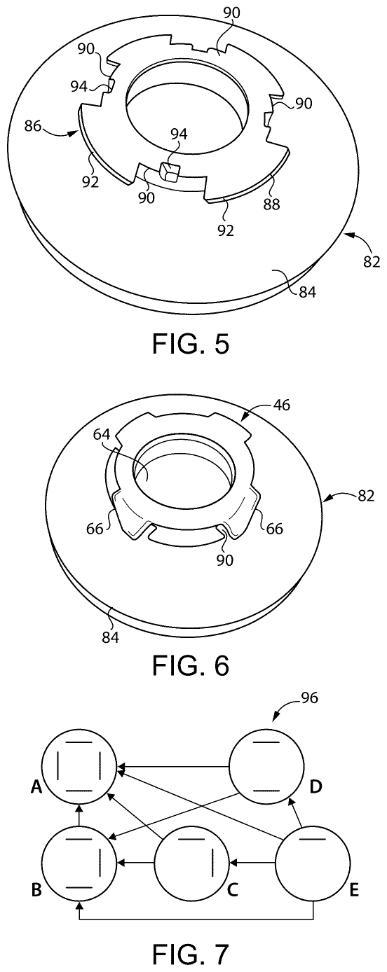

Filter element 114, 214 includes an end cap 182, 282 connected to first axial end 178, 278. As shown in FIG. 5, end cap 182, 282 may include a disk portion 84 and a connector portion 86 having a radial projection 88. It should be appreciated that the forthcoming description of endcap 82 applies to both endcap 182 and endcap 282 by way of analogy. As also illustrated, connector portion 86 has a structure resembling a platform but is not limited to such. A plurality of notches 90, each respective notch opening at a radially outward edge 92 of end cap, may be formed within radial projection 88. It should be appreciated that the arrangement and/or positioning of notches may be generally patterned after the arrangement and/or positioning of keys 66. For example, each notch 90 may be radially dispersed about filter axis 42 in a manner akin to keys 66. Notches 90 are incorporated in end cap 82 to provide corresponding attachment features for keys 66. As seen in FIG. 6, attachment ring 46 facilitates the installation of a fresh filter element. The total number of the plurality of notches may differ based on various factors, such as the arrangement of corresponding keys and/or a desired filter performance factor of a filter element, as further discussed herein.

In a practical implementation, filter element 114 is designed to be interchangeable for service with filter element 214. It should be appreciated that while filter elements 114, 214 can interchangeably be installed within filter system 10, filter element 114, 214 may each have a filter performance factor that is the same, or different, provided both are suitable for the intended application. Thus, “interchangeable for service” means that each is capable of installation for service and operation to filter a fluid, although not necessarily giving the same efficiency or otherwise performance. In this example, end cap 182 can have a total number of 1, 2, 3, or 4 notches, and end cap 282 can have a total number of 1, 2, 3, or 4 notches that is different from the total number of notches in filter element 114. In another example the total number of keys can be equal to a total number of the 1 to 12 notches for filter element 114, 214. The total number of notches 90 formed within a filter element relative to the total number of keys 66 may vary, where fewer keys 66 than notches 90 is permissible. In a practical implementation, attachment ring 46 can accommodate a number of filter elements, provided the notches of each filter element are co-located at a position.

Another way to understand this principle is that provided there is at least one key 66 positionable within a corresponding notch 90, attachment of at least attachment ring 46 to end cap 82 can be accomplished. To further secure each key 66 within its corresponding notch 90, filter element 14 may include a detent pocket 94 formed within each respective notch 90. It should be appreciated that keys 66 can be paired with various filter elements 14, each defining different filter performance factors, to establish a plurality of attachment configurations. If an incompatible or undesirable filter element having an unfavorable filter performance factor is selected, keys 90 restrict installation to ensure only suitable filters are used.

### INDUSTRIAL APPLICABILITY

Referring to the drawings generally, it will be recalled that a first filter element 114 includes end cap 182 having a total number of 1, 2, 3, or 4 notches 190, and a second filter element 214 includes end cap 230 having a total number of 1, 2, 3, or 4 notches 290 that is different from the first filter element 114. Filter base 18 includes attachment ring 46 having a total number of 1, 2, 3, or 4 keys corresponding to the total number of notches in the first filter element 114 and the second filter element 214.

FIG. 7 illustrates a schematic illustration of exemplary key and notch attachment configurations for a fluid filter system. Each identified configuration represents a potential placement of keys 166, 266, and each arrow denotes one or more potential notch 190, 290 and key 166, 266 pairing configurations. Emphasis is placed on two configurations: configuration A, or the universal notch, and configuration E, or the universal key. The universal key is designed with a single key that is configured to fit any arrangement of notches 190, 290. Conversely, the universal notch is equipped with the maximum number of notches for any given attachment system to accommodate any configuration of keys, and therefore a wider array of filter elements.

The present description is for illustrative purposes only and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A filter system comprising:
a filter element defining a filter axis extending between a first axial end and a second axial end, the filter element having a filter medium extending circumferentially around the filter axis, and an end cap connected to the first axial end, the end cap including a plurality of notches extending radially inward, formed within the end cap;
a filter base defining an axis having a mounting portion; and
an attachment ring connected to the mounting portion, the attachment ring including at least one key positionable within a corresponding one of the plurality of notches, the at least one key axially extending in a direction away from the mounting portion.

2. The filter system of claim 1 wherein the plurality of notches includes a total number of 1, 2, 3, or 4 notches in the end cap, and each of the respective 1, 2, 3, or 4 notches opens at a radially outward edge of the end cap.

3. The filter system of claim 1 further including a second filter element interchangeable for service with the first filter element but having an end cap including a total number of notches that is different from a total number of notches in the end cap of the first filter element.

4. The filter system of claim 3 wherein the plurality of notches of the first filter element and the plurality of notches of the second filter element are radially distributed in the respective end caps and one of plurality of notches in the first filter element and second filter element and at least one of the plurality of notches of the each the first filter element and the second filter element are co-located at a position.

5. The filter system of claim 3 wherein the filter medium of the first filter element defines a first filter performance factor, and a second filter medium of the second filter element defines a second filter performance factor different than the first filter performance factor.

6. The filter system of claim 1 wherein the at least one key includes a total number less than a total number of keys less than the total number of notches.

7. The filter system of claim 1 wherein the at least one key includes a total number of keys equal to a total number of the plurality of notches.

8. The filter system of claim 1 wherein the attachment ring is freely rotatable about the filter axis, relative to the mounting portion.

9. The filter system of claim 1 wherein the end cap includes a disk portion, and a connector portion having a radial projection, and the plurality of notches are formed in the radial projection.

10. The filter system of claim 1 wherein the attachment ring includes an inner attachment ring surface, and a groove formed in the inner attachment ring surface, and a rib seated within the groove matingly couples the filter base to the attachment ring.

11. A filter mount comprising:
a filter base including a filter base body defining an axis extending in a direction away from the filter base body, and a mounting portion for a filter element located at a distance from the filter base body; and
a freely rotatable attachment ring connected to the mounting portion, the attachment ring including an annular portion having an inner attachment ring surface extending around the axis, and an attachment portion having a plurality of keys axially extending in the direction away from the filter base body.

12. The filter mount of claim 11 wherein a number of the plurality of keys is 1, 2, 3, or 4.

13. The filter mount of claim 11 further including a groove formed in the inner attachment ring surface, and a rib circumferentially extending around the mounting portion, seated within the groove, and coupling the filter base to the attachment ring.

14. The filter mount of claim 12 wherein each one of the plurality of keys is radially distributed around the axis.

15. The filter mount of claim 11 wherein each one of the plurality of keys extends from a key base coupled to the annular portion, to a key tip, and wherein each of the plurality of keys extends outwardly relative to the axis from the key base to the key tip.

16. The filter mount of claim 15 wherein a total number of the at least one key is 1.

17. An inventory of filter elements, comprising:
a first filter element defining a first axis extending away from a first axial end, a first filter medium extending circumferentially around the filter axis, and a first end cap connected to the first axial end, the first end cap including a connector portion having a radial projection, and a first plurality of notches opening at a radially outward edge of the end cap;
a second filter element defining a second axis extending away from a second axial end, a second filter medium extending circumferentially around the second filter axis, and a second end cap connected to the second axial end, the second end cap including a connector portion having a radial projection, and a second plurality of notches opening at a radially outward edge of the second end cap; and
the first filter element defining a first filter performance factor, and the second filter element defining a second filter performance factor different from the first filter performance factor, and the first filter element and the second filter element being interchangeable for service in a fluid filter system.

18. The inventory of claim 17 wherein a total number of the first plurality of notches is different from a total number of the second plurality of notches.

19. The inventory of claim 18 wherein the total number of the first plurality of notches is 1, 2, 3, or 4, and the total number of the second plurality of notches is 1, 2, 3, or 4.

20. The inventory of claim 18 wherein the first plurality of notches of the first filter element and the second plurality of notches of the second filter element are radially distributed in the respective end caps.
